(19) United States
(12) Patent Application Publication
(10) Pub. No.: US 2022/0176506 A1
(43) Pub. Date: Jun. 9, 2022

(54) TOOL STORAGE AND MACHINE TOOL

(71) Applicant: Yamazaki Mazak Corporation, Niwa-gun (JP)

(72) Inventors: Tomohiro KINTOKI, Niwa-gun (JP); Seiya ONO, Niwa-gun (JP); Reiji MAEKAWA, Niwa-gun (JP); Mitsumasa IEDA, Niwa-gun (JP); Keijiro KINOSHITA, Niwa-gun (JP); Kenji YOSHIMOTO, Niwa-gun (JP); Masaki TANASE, Niwa-gun (JP)

(73) Assignee: Yamazaki Mazak Corporation, Niwa-gun (JP)

(21) Appl. No.: 17/679,096

(22) Filed: Feb. 24, 2022

Related U.S. Application Data
(63) Continuation of application No. PCT/JP2019/033511, filed on Aug. 27, 2019.

(51) Int. Cl. B23Q 3/155; B23Q 3/157

(52) U.S. Cl. CPC B23Q 3/15539; B23Q 3/15713; B23Q 3/1554

(57) ABSTRACT

A tool storage includes a tool receiver, a tool magazine, and a tool carriage. The tool receiver is provided on a one side of a machine tool with respect to a workpiece holder of the machine tool along a machine tool direction and is configured to receive a tool from an outside of the machine tool. The tool magazine is provided on another side opposite to the one side with respect to the workpiece holder along the machine tool direction. The tool carriage is configured to carry the tool between the tool receiver and the tool magazine.

### CROSS-REFERENCE TO RELATED APPLICATIONS

The present application is a continuation application of International Application No. PCT/JP2019/033511, filed Aug. 27, 2019. The contents of this application are incorporated herein by reference in their entirety.

### BACKGROUND OF THE INVENTION

### Field of the Invention

The present invention relates to a tool storage and a machine tool.

### Discussion of the Background

Such machine tools have been known that include a magazine for storing a plurality of tools.

JP5154178B2 shows a multi-tasking lathe. In the multi-tasking lathe shown in JP5154178B2, a door is provided on the front surface of a cover for a tool magazine apparatus so that the tool magazine apparatus can be accessed through the door.

### SUMMARY OF THE INVENTION

According to one aspect of the present invention, a tool storage includes a tool receiver, a tool magazine, and a tool carriage. The tool receiver is provided on a one side of a machine tool with respect to a workpiece holder of the machine tool along a machine tool direction and is configured to receive a tool from an outside of the machine tool. The tool magazine is provided on another side opposite to the one side with respect to the workpiece holder along the machine tool direction. The tool carriage is configured to carry the tool between the tool receiver and the tool magazine.

According to another aspect of the present invention, a machine tool includes a workpiece holder, a machining apparatus, a tool receiver, a tool magazine, and a tool carriage. The workpiece holder is configured to hold a workpiece. A tool is attachable to the machining apparatus. The tool receiver is provided between the workpiece holder and a front of the machine tool and is configured to receive a tool from an outside of the machine tool. The tool magazine is provided between the workpiece holder and a back of the machine tool. The tool carriage is configured to carry the tool between the tool receiver and the tool magazine.

According to the other aspect of the present invention, a tool storage includes a housing, a tool receiver, a tool magazine, and a tool carriage. The housing has a front and a back. The front has an access opening. The tool receiver is provided in the housing and is configured to receive a tool from an outside of the machine tool via the access opening. The tool magazine is provided in the housing between the tool receiver and the back of the housing. The tool carriage is configured to carry the tool between the tool receiver and the tool magazine.

### BRIEF DESCRIPTION OF DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a schematic side view of a tool storage according to a first embodiment;

FIG. 2 is a schematic side view of a machine tool according to the first embodiment;

FIG. 3 is a schematic plan view of the machine tool according to the first embodiment;

FIG. 4 is a schematic plan view of another example of the machine tool according to the first embodiment;

FIG. 5 is a schematic perspective view of a machine tool according to a second embodiment;

FIG. 6 is a schematic perspective view of an example tool receiver;

FIG. 7 is a schematic perspective view of an enlarged part of the machine tool;

FIG. 8 is a schematic perspective view of an enlarged part of the machine tool;

FIG. 9 is a schematic perspective view of an example carrier;

FIG. 10 is a schematic perspective view of an example carrier;

FIG. 11 is a schematic side view of an example tool;

FIG. 12 is a schematic perspective view of an enlarged part of the machine tool;

FIG. 13 is a schematic perspective view of an enlarged part of the machine tool;

FIG. 14 is a schematic perspective view of an enlarged part of another example of the machine tool;

FIG. 15 is a schematic perspective view of an enlarged part of the machine tool; and

FIG. 16 is a schematic perspective view of a machine tool according to a third embodiment.

### DESCRIPTION OF THE EMBODIMENTS

By referring to the accompanying drawings, a tool storage 1 and a machine tool 100 according to some embodiments of the present invention will be described. It is noted that in the following description of the embodiments, identical reference numerals are used to denote identical portions, members, or components having identical functions, and redundant description of identical portions, members, or components will be eliminated or minimized.

### Definitions of Terms

A tool carried to a machining apparatus 30 from a tool receiver 10 or a tool magazine 20 will be referred to as “first the tool C1”, and a tool carried to the tool receiver 10 or the tool magazine 20 from the machining apparatus 30 will be referred to as “second the tool C2”. Also, a tool that can be stored in the magazines such as the tool magazine 20, a second tool magazine 20b, and an auxiliary magazine 70 or that can be attached to the machining apparatus 30 will be referred to as “tool C”. The first tool C1 and the second tool C2 are encompassed within the scope of the tool C.

In this specification, a machine tool means any machine capable of machining a workpiece, which is a to-be-machined object. The machine tool may be a combined multi-functional machine tool (for example, a multi-tasking lathe), which is capable of performing a plurality of different kinds of machining. For example, the machine tool is a machine capable of cutting, machining, and/or grinding a metal.

### First Embodiment

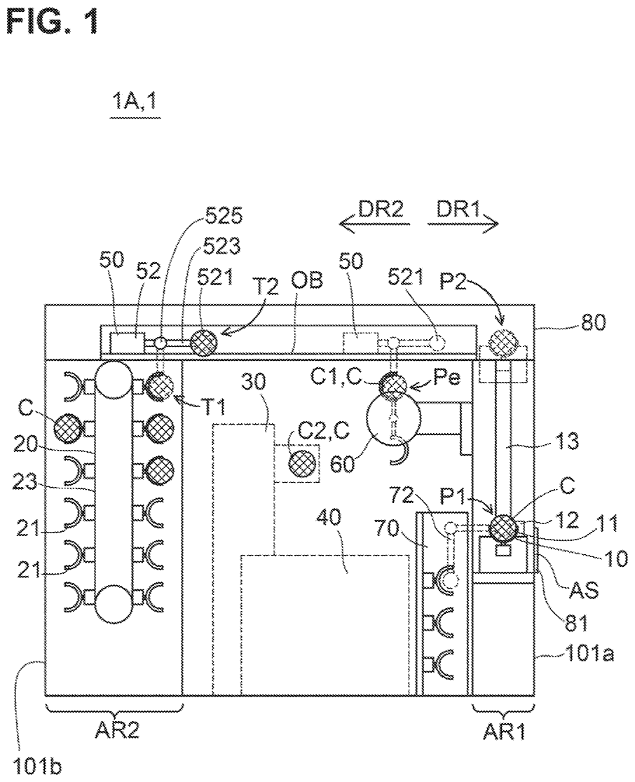

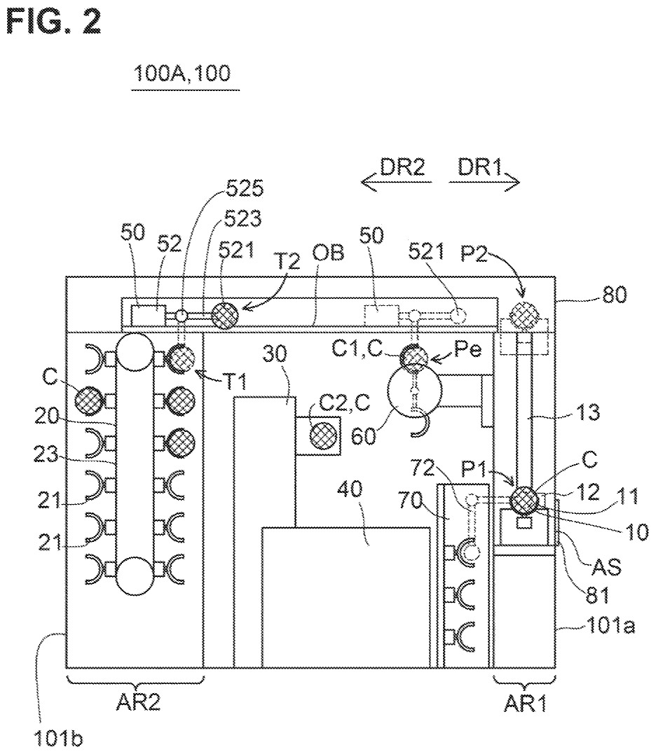

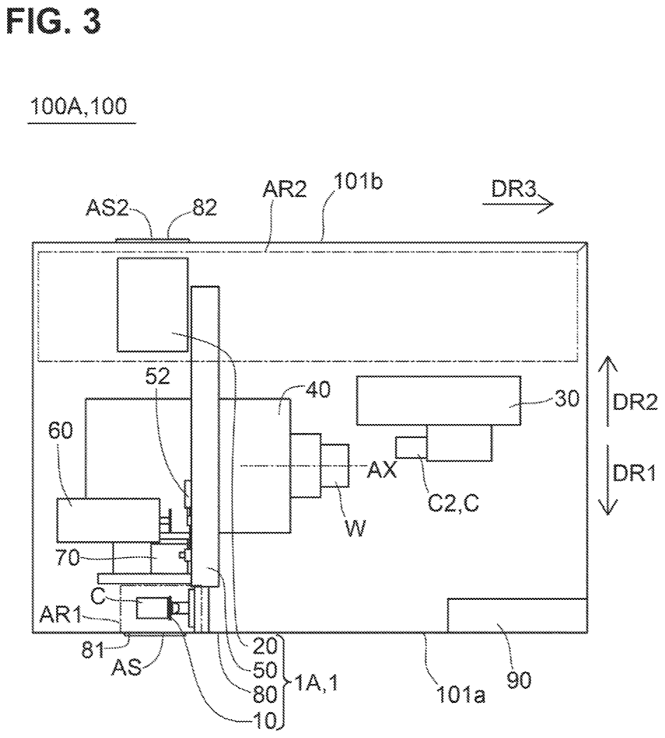

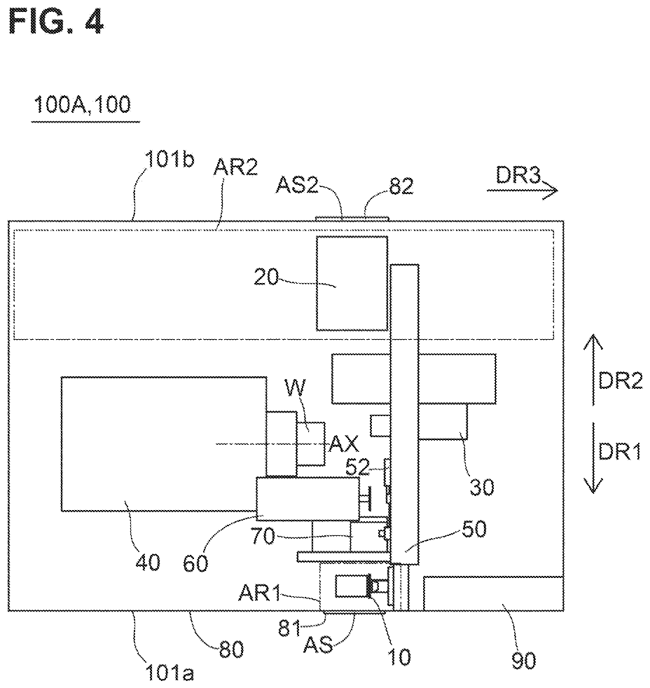

By referring to FIGS. 1 to 4, a tool storage 1A and a machine tool 100A according to the first embodiment will be described. FIG. 1 is a schematic side view of the tool storage 1A according to the first embodiment. FIG. 2 is a schematic side view of the machine tool 100A according to the first embodiment. FIG. 3 is a schematic plan view of the machine tool 100A according to the first embodiment. FIG. 4 is a schematic plan view of another example of the machine tool 100A according to the first embodiment.

In the example illustrated in FIG. 1, the tool storage 1A according to the first embodiment includes the tool receiver 10 (tool receiver), the tool magazine 20, and a tool carriage 50. The tool storage 1A may include a tool exchanger 60.

In the example illustrated in FIG. 2, the machine tool 100A according to the first embodiment includes, in addition to the tool storage 1A: the machining apparatus 30, which machines a workpiece; and a workpiece holder 40, which holds the workpiece.

The tool receiver 10 is a device capable of receiving the tool C from outside the machine tool 100A. A worker or a robot is able to provide the tool C to the tool receiver 10 from outside the machine tool 100A. Providing the tool C to the tool receiver 10 may be performed by placing the tool C on the tool receiver 10 or by attaching the tool C to a tool support member 11 of the tool receiver 10.

The tool magazine 20 is capable of storing therein the tool C. The tool magazine 20 includes a tool holder 21, which is capable of holding the tool C. In the example illustrated in FIG. 1, the tool magazine 20 includes a plurality of tool holders 21. The plurality of tool holders 21 are capable of holding a plurality of tools C. In other words, the tool magazine 20 is capable of storing a plurality of tools C via the plurality of tool holders 21.

In the example illustrated in FIG. 1, the tool magazine 20 includes an endless chain 23. On the endless chain 23, the plurality of tool holders 21 are mounted. The endless chain 23 is drivable into rotation by a driver to make a circulation movement of the plurality of tool holders 21.

The tool C can be attached to the machining apparatus 30, which constitutes a part of the machine tool 100A. The machining apparatus 30 is capable of moving the tool C toward a workpiece held by the workpiece holder 40. In this manner, the workpiece is machined (for example, cut, machined, or ground) by the tool C. The machining apparatus 30 is preferably capable of moving the tool C in a desired direction.

The workpiece holder 40, which constitutes a part of the machine tool 100A, is capable of holding a workpiece, which is a to-be-machined object. In the example illustrated in FIG. 3, the workpiece holder 40 may support a workpiece W rotatably about a rotation axis AX.

The tool carriage 50 is a device capable of carrying the tool C. The tool carriage 50 may be made up of a single carrier or a combination of a plurality of carriers.

In the example illustrated in FIG. 3, in plan view, the tool receiver 10 is provided at a position further in a first direction DR1 than the workpiece holder 40. An example of the first direction DR1 is a direction extending from the back surface, 101b, of the machine tool 100A (the back surface of the machine tool 100A) toward the front surface, 101a, of the machine tool. Namely, the tool receiver 10 is provided on a one side of a machine tool 100A with respect to the workpiece holder 40 of the machine tool 100A along a machine tool direction (DR1 and DR2).

Also in the example illustrated in FIG. 3, in plan view, the tool magazine 20 is provided at a position further in a second direction DR2 than the workpiece holder 40. It is to be noted that the second direction DR2 is a direction opposite to the first direction DR1. An example of the second direction DR2 is a direction extending from the front surface 101a of the machine tool 100A toward the back surface 101b (the back surface of the machine tool 100A) of the machine tool. Namely, the tool magazine 20 is provided on another side opposite to the one side with respect to the workpiece holder 40 along the machine tool direction (DR1 and DR2).

In the example illustrated in FIG. 3, the tool carriage 50 is capable of carrying the tool C between: the tool receiver 10, which is provided at a position further in the first direction DR1 than the workpiece holder 40; and the tool magazine 20, which is provided at a position further in the second direction DR2 than the workpiece holder 40. The tool receiver 10 is provided in a first region AR1, and the tool magazine 20 is provided in a second region AR2, which is opposite to the first region AR1. The above configuration ensures that by providing the tool C to the tool receiver 10, the tool C can be stored in the second region AR2.

In the tool storage 1A (or the machine tool 100A) according to the first embodiment, the tool magazine 20 is provided at a position further in the second direction DR2 than the workpiece holder 40. This configuration prevents the tool magazine 20 from protruding in the first direction DR1 (for example, toward the front surface) of the machine tool 100A. The above configuration also eliminates the need for a design change on the machine tool 100A's first direction DR1-side shape (for example, the front surface shape) based on the size of the tool magazine 20. In other words, the machine tool 100A's first direction DR1-side shape (for example, the front surface shape) can be designed without restrictions associated with the size and/or the shape of the tool magazine 20. For example, it is easier to make the front surface-side shape of the machine tool 100A a flat shape. When the front surface-side shape of the machine tool 100A is a flat shape, automation units (such as a robot, an automatic carrier, and an auto parts catcher) can be arranged with a higher degree of freedom on a machining line on which a various kinds of machines are aligned.

However, in the configuration in which the tool magazine 20 is provided at a position further in the second direction DR2 than the workpiece holder 40, a worker or a robot is unable to make access to the tool magazine 20 from the first direction DR1-side (for example, from the front surface side of the machine tool 100A). Under the circumstances, in order to store the tool C in the tool magazine 20 (or in order to take the tool C out of the tool magazine 20), it is necessary for a worker, for example, to move additionally. For example, it is necessary for a worker to move from the back surface side to the front surface side of the machine tool 100A.

In light of the considerations above, in the first embodiment, the tool receiver 10 is provided in a region on the first direction DR1-side, in order to improve accessibility of the tool magazine 20. In this case, a worker or a robot is able to more easily make access to the tool receiver 10 from the first direction DR1-side (for example, from the front surface side of the machine tool 100A).

Additionally, in the first embodiment, the tool carriage 50 is provided to carry the tool C between the region on the first direction DR1-side and the region on the second direction DR2-side. This ensures that the tool C at the tool receiver 10 can be stored in the tool magazine 20, which is provided in the region (on the second direction DR2-side) opposite to the region (on the first direction DR1-side) in which the tool receiver 10 is provided.

In this manner, pseudo-accessibility of the tool magazine 20 from the first direction DR1-side is ensured. In other words, a worker or a robot is able to make access to the tool magazine 20 from the first direction DR1-side via the tool receiver 10 and the tool carriage 50.

It is to be noted that in the first embodiment, the tool carriage 50 is preferably capable of carrying the tool C received by the tool receiver 10 to the tool magazine 20 directly (in other words, without intervention of the machining apparatus 30). In this case, the tool C supplied from outside the machine tool 100A can be stored in the tool magazine 20 without suspending the workpiece machining performed by the machining apparatus 30.

Thus, in the first embodiment, the tool magazine 20 can be provided in the region on the second direction DR2-side without undermining accessibility of the tool magazine 20 from the first direction DR1-side.

In the example illustrated in FIG. 3, the tool carriage 50 is provided such that the tool carriage 50 passes immediately over the workpiece holder 40. Also, in plan view, the tool receiver 10, the workpiece holder 40, and the tool magazine 20 are provided on a line. Alternatively, as in the example illustrated in FIG. 4, in plan view, the tool receiver 10, the workpiece holder 40, and the tool magazine 20 may not necessarily be provided on a line. In other words, in the first embodiment, the workpiece holder 40 may be provided at any convenient position in the lateral direction of the workpiece holder 40 (that is, in a third direction DR3, which is a direction perpendicular to the first direction DR1 and the vertical direction).

In the above examples, description has been made with regard to a position of the tool receiver 10 relative to the workpiece holder 40 and a position of the tool magazine 20 relative to the workpiece holder 40. Next, description will be made with regard to positions of the tool receiver 10 and the tool magazine 20 relative to an access opening AS.

In the example illustrated in FIG. 3, the tool storage 1A (or the machine tool 100A) includes a housing 80. The housing 80 has the access opening AS, through which the inside of the machine tool 100A is accessible.

In the housing 80, elements such as the tool receiver 10, the tool magazine 20, the machining apparatus 30, the workpiece holder 40, and the tool carriage 50 are provided. In the housing 80, the tool exchanger 60 may be provided.

The tool receiver 10 is provided in the first region AR1, which is a region in the housing 80 and accessible through the access opening AS. In this case, a worker or a robot is able to provide, through the access opening AS, the tool C to the tool receiver 10, which is provided in the housing 80.

In the example illustrated in FIG. 3, the tool receiver 10 is unable to move to the outside of the housing 80. Alternatively, the tool receiver 10 may be able to move to the outside of the housing 80 through the access opening AS. In other words, the tool receiver 10 may move to the outside of the housing 80 and receive the tool C, and then the tool receiver 10 provided with the tool C may move into or make access to the inside of the housing 80 through the access opening AS.

The tool magazine 20 is provided in the second region AR2 of the inside of the housing 80. The second region AR2 is a region further away from the access opening AS than the first region AR1 is away from the access opening AS.

The second region AR2, in which the tool magazine 20 is provided, may be a region that is, in plan view, further away from the access opening AS than the rotation axis AX of the workpiece holder 40 is away from the access opening AS. Alternatively, the second region AR2, in which the tool magazine 20 is provided, may be a region that is, in plan view, further away from the access opening AS than the tool exchanger 60 is away from the access opening AS.

The tool carriage 50 is capable of carrying the tool C between: the tool receiver 10, which is provided in the first region AR1; and the tool magazine 20, which is provided in the second region AR2.

In the example illustrated in FIG. 3, a worker or a robot is able to provide the tool C to the tool receiver 10. The tool C provided at the tool receiver 10 is carried by the tool carriage 50 to the tool magazine 20, which is provided in the second region AR2 (the second region AR2 is further away from the access opening AS).

Thus, in the first embodiment, without undermining accessibility of the tool magazine 20, the tool magazine 20 is provided in the second region AR2, which is further away from the access opening AS.

Next, by referring to FIGS. 1 to 4, an optional configuration employable in the first embodiment will be described.

As illustrated in FIGS. 1 and 2, the tool storage 1A (or the machine tool 100A) may include the tool exchanger 60, which exchanges the first tool C1 and the second tool C2 with each other. The first tool C1 is carried to a tool exchange position Pe by the tool carriage 50. The second tool C2 is attachable to the machining apparatus 30.

In the examples illustrated in FIGS. 1 and 2, the tool storage 1A (or the machine tool 100A) includes the tool exchanger 60, and the tool carriage 50 is capable of carrying the first tool C1 received from the tool receiver 10 to the tool exchange position Pe. This configuration ensures that the first tool C1 provided at the tool receiver 10 by a worker or a robot is carried to the tool exchange position Pe by the tool carriage 50. The above configuration also ensures that the first tool C1 carried to the tool exchange position Pe is attached to the machining apparatus 30 by the tool exchanger 60.

In the examples illustrated in FIGS. 1 and 2, the tool carriage 50 is capable of carrying the first tool C1 received from the tool receiver 10 to the tool exchange position Pe directly (in other words, without intervention of the tool magazine 20). In this case, the first tool C1 supplied from outside the machine tool 100A can be quickly attached to the machining apparatus 30. The first tool C1 carried to the tool exchange position Pe may be a tool storable in the tool magazine 20 or may be a tool difficult to store in the tool magazine 20. In other words, a first tool C1 difficult to store in the tool magazine 20 can be carried to the tool exchange position Pe, and this first tool C1 can be attached to the machining apparatus 30.

As illustrated in FIG. 3, the tool storage 1A (or the machine tool 100A) may include a controller 90, which controls the tool carriage 50 and the tool exchanger 60.

By controlling the tool carriage 50, the controller 90 executes a first control mode, in which the tool C is carried from the tool receiver 10 to the tool magazine 20. In the first control mode, the tool C is stored in the tool magazine 20 without intervention of the machining apparatus 30. This ensures that the tool C is quickly stored in the tool magazine 20.

The controller 90 executes a second control mode, in which: the controller 90 controls the tool carriage 50 to carry the first tool C1 from the tool receiver 10 to the tool exchange position Pe; and controls the tool exchanger 60 to cause the first tool C1 provided at the tool exchange position Pe to be attached to the machining apparatus 30. In the second control mode, the first tool C1 is attached to the machining apparatus 30 without intervention of the tool magazine 20. This ensures that the first tool C1 is quickly attached to the machining apparatus 30.

The controller 90 is preferably capable of selectively executing the first control mode and the second control mode. In this case, the storing of the tool C at the tool receiver 10 in the tool magazine 20 and the attaching of the first tool C1 at the tool receiver 10 to the machining apparatus 30 can be executed selectively.

As illustrated in FIGS. 1 and 2, the tool carriage 50 may include a carrier 52, which is movable along a trajectory OB. The carrier 52 may include: a holder 521, which is capable of holding the tool C; an aim 523, which supports the holder 521; and a first driver 525, which moves the arm 523 between a first proceeding position T1 and a first withdrawal position T2. The first proceeding position T1 corresponds to a position at which the tool C is transferable between the tool magazine 20 (or the tool exchanger 60) and the holder 521. The first withdrawal position T2 corresponds to a position other than the first proceeding position T1.

When the holder 521 is movable to the first proceeding position T1, the tool C can be smoothly transferable between the holder 521 and the tool magazine 20 (or the tool exchanger 60). When the holder 521 is movable to the first withdrawal position T2, the tool C is prevented from interfering with some other apparatus or device while the tool C is being carried by the tool carriage 50.

As illustrated in FIGS. 1 and 2, the tool receiver 10 may include: the tool support member 11, which supports the tool C; and a driver 12, which moves the tool support member 11 between a first position P1 and a second position P2. The first position P1 is a position at which the tool support member 11 is able to receive the tool C from outside the machine tool 100A. The second position P2 is a position at which the tool C is transferable from the tool support member 11 to the tool carriage 50. In the examples illustrated in FIGS. 1 and 2, the second position P2 is positioned above the first position P1. The tool receiver 10 may include a guide member 13, which guides the movement of the tool support member 11 (an example of the guide member 13 is a guide column extending in the vertical direction).

When the tool support member 11 is movable to the first position P1, a worker or a robot is able to easily make access to the tool support member 11 at the first position P1. When the tool support member 11 is movable to the second position P2, the tool carriage 50 is able to easily make access to the tool support member 11 at the second position P2. This eliminates or minimizes complication of the carrying passage defined by the tool carriage 50.

In the examples illustrated in FIGS. 1 and 2, the position at which the tool receiver 10 receives the tool C from outside the machine tool 100A is defined as the first position Pl, and the carrying passage defined by the tool carriage 50 (for example, the trajectory OB) is positioned above the first position P1. In other words, in the examples illustrated in FIGS. 1 and 2, the tool carriage 50 is provided in an upper region of the machine tool 100A. In this case, the upper region of the machine tool 100A is effectively used, and as a result, the machine tool 100A becomes compact in size.

In the example illustrated in FIG. 3, the tool storage 1A (or the machine tool 100A) includes the housing 80, which has the access opening AS, through which the inside of the machine tool 100A is accessible. The tool receiver 10 is provided in a region accessible through the access opening AS. The housing 80 may be provided with a door 81, which makes the access opening AS openable and closable.

In the example illustrated in FIG. 3, the housing 80 has a second access opening AS2, through which the tool magazine 20 is directly accessible. The tool magazine 20 is provided in a region accessible through the second access opening AS2. For example, the second access opening AS2 is provided at a position further in the second direction DR2 than the tool magazine 20. The housing 80 may be provided with a door 82, which makes the second access opening AS2 openable and closable.

When the tool storage 1A (or the machine tool 100A) has the access opening AS, a worker is able to perform the work of storing the tool C from the first direction DR1-side of the machine tool 100A. When the tool storage 1A (or the machine tool 100A) has the second access opening AS2, the worker is able to make direct access to the tool magazine 20 through the second access opening AS2. In this case, a plurality of tools C can be quickly stored in the tool magazine 20.

As illustrated in FIGS. 1 and 2, the tool storage 1A (or the machine tool 100A) may include: the auxiliary magazine 70, in which the tool C is storable; and a tool transferor 72. The tool transferor 72 transfers the tool C between the tool receiver 10 and the auxiliary magazine 70.

When the tool C is stored the auxiliary magazine 70, the tool C can be stored without intervention of the tool carriage 50. This ensures that the tool C provided at the tool receiver 10 can be quickly stored in the auxiliary magazine 70. The auxiliary magazine 70 is preferably capable of storing a plurality of tools C. The auxiliary magazine 70 may store a tool storable in the tool magazine 20 or may store a specialized tool difficult to store in the tool magazine 20.

In the example illustrated in FIG. 3, the auxiliary magazine 70 is provided in a region closer to the access opening AS than to the second region AR2, in which the tool magazine 20 is provided. Also in the example illustrated in FIG. 3, the auxiliary magazine 70 is provided at a position further in the first direction DR1 than the workpiece holder 40.

### Second Embodiment

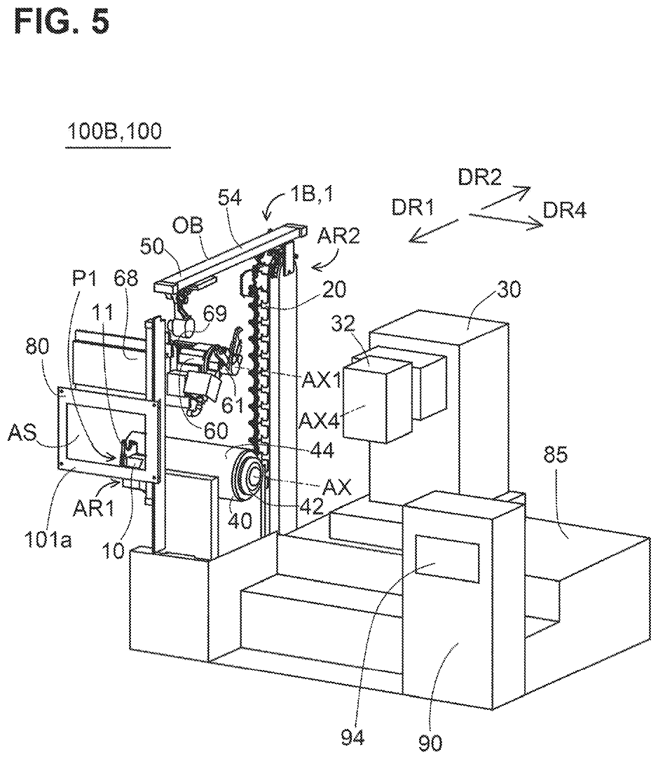

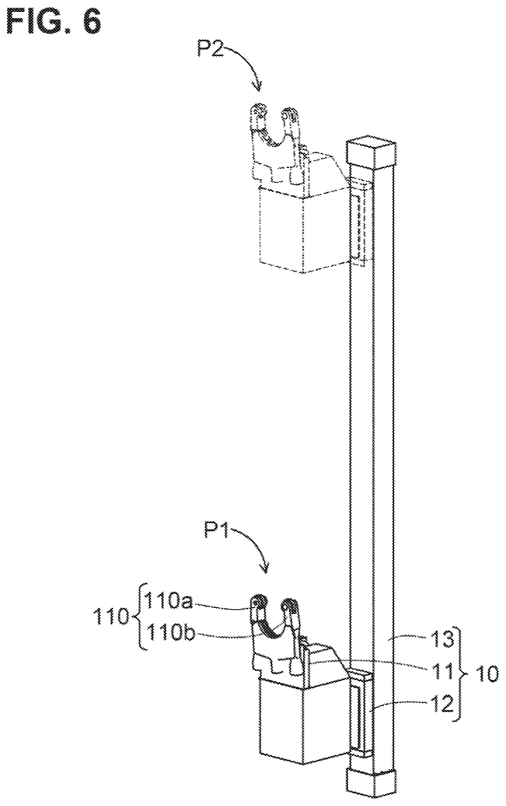

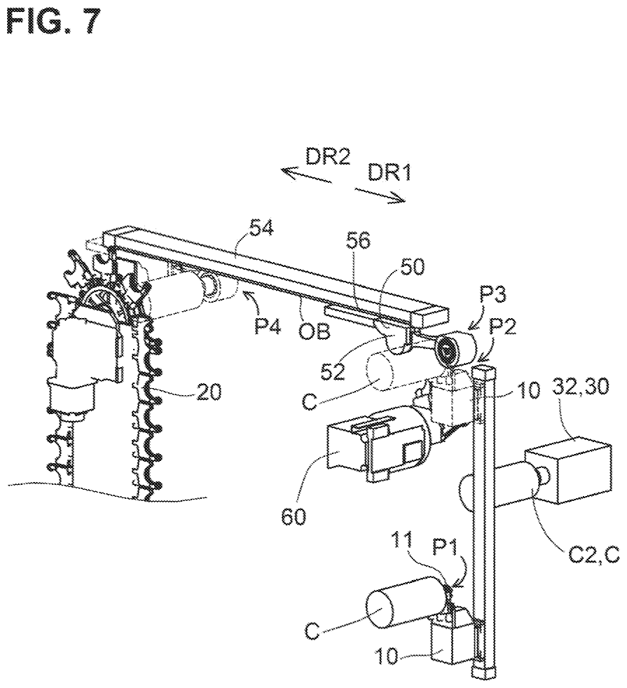

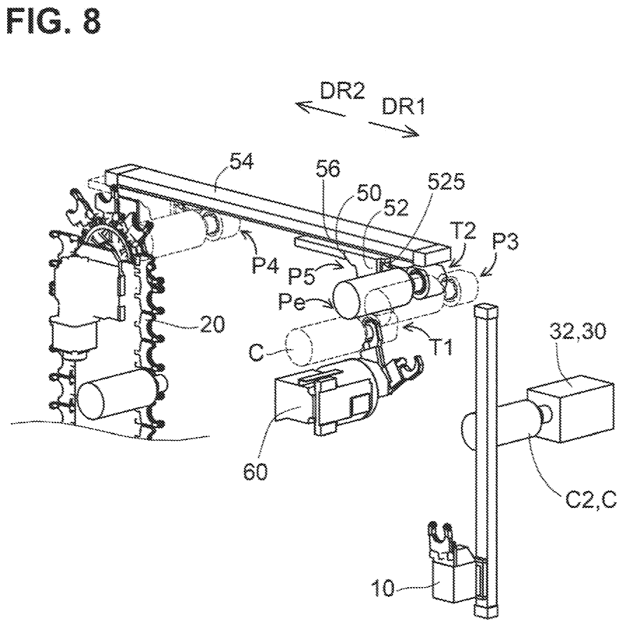

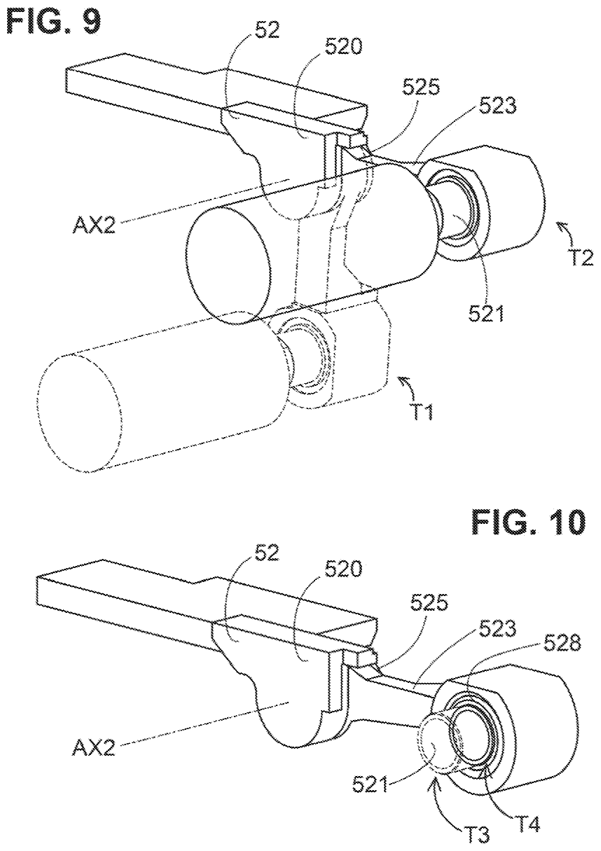

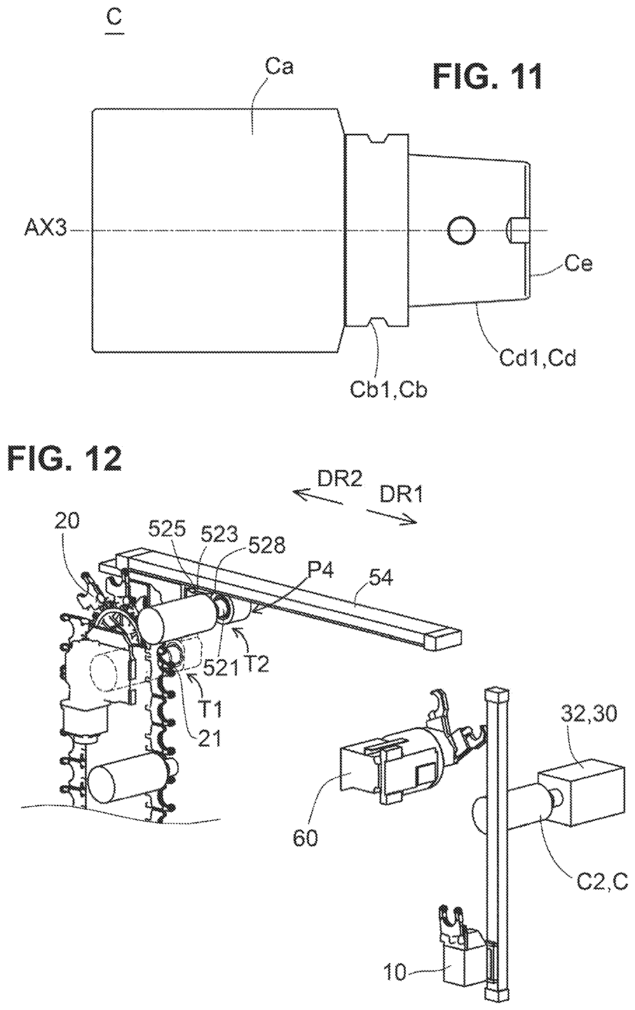

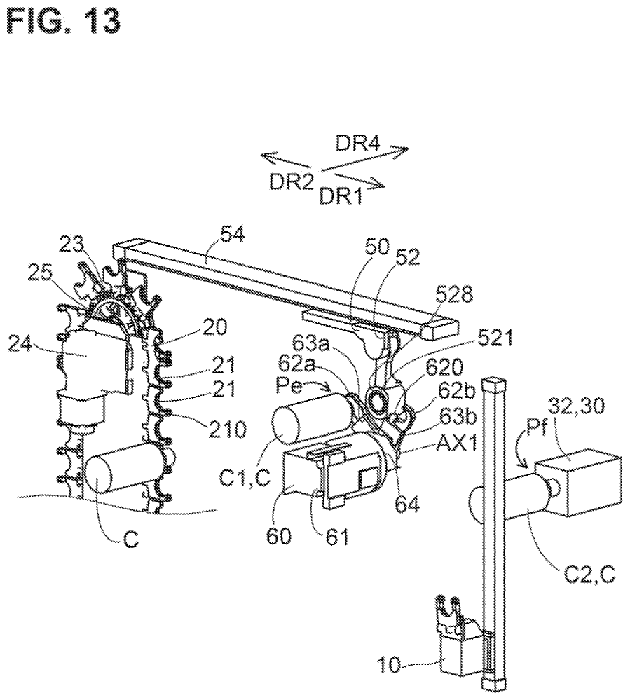

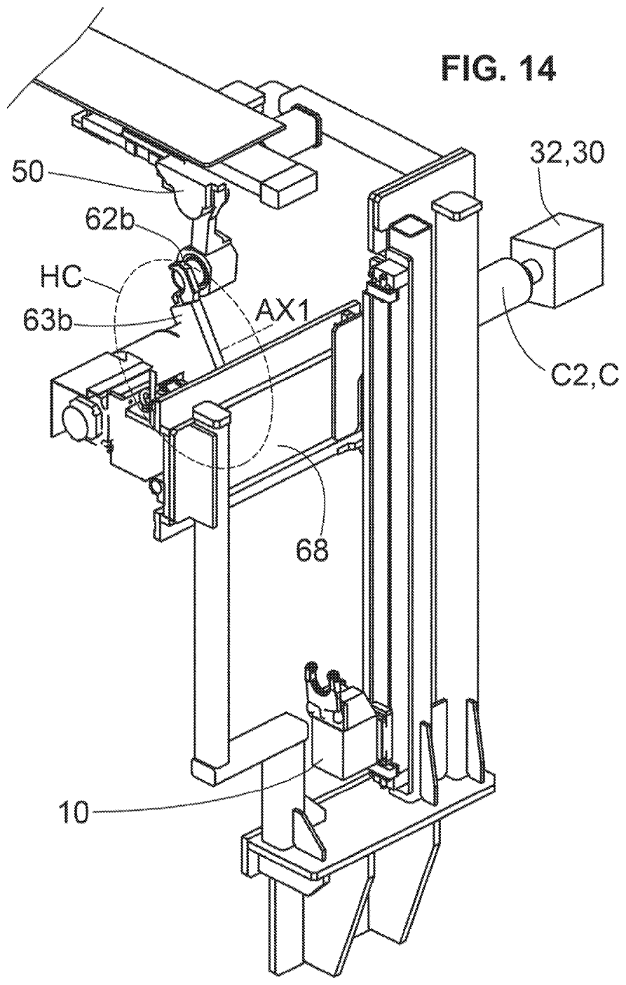

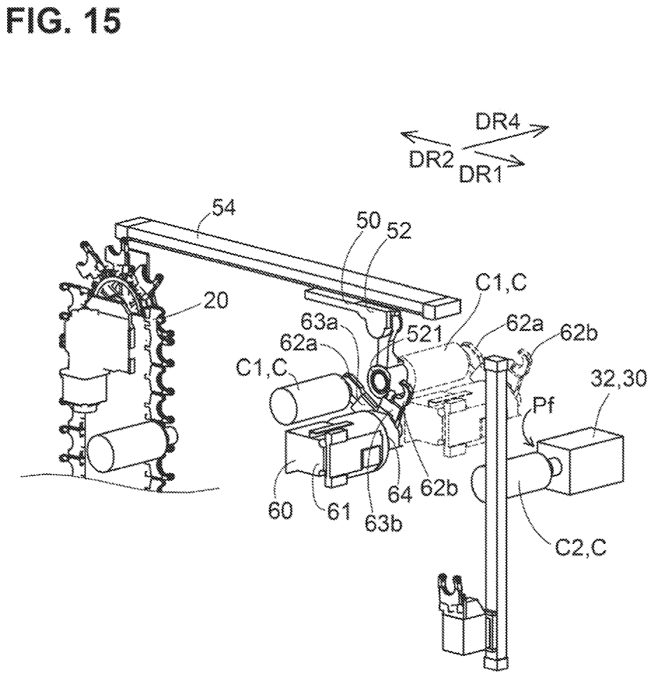

By referring to FIGS. 5 to 15, a tool storage 1B and a machine tool 100B according to the second embodiment will be described. FIG. 5 is a schematic perspective view of the machine tool 100B according to the second embodiment. FIG. 6 is a schematic perspective view of an example of the tool receiver 10. FIGS. 7 and 8 each are a schematic perspective view of an enlarged part of the machine tool 100B. FIGS. 9 and 10 each are a schematic perspective view of an example of the carrier 52. FIG. 11 is a schematic side view of an example the tool C. FIGS. 12 and 13 each are a schematic perspective view of an enlarged part of the machine tool 100B. FIG. 14 is a schematic perspective view of an enlarged part of another example of the machine tool 100B. FIG. 15 is a schematic perspective view of an enlarged part of the machine tool 100B. It is to be noted that in FIGS. 5, 7, 8, and FIGS. 12 to 15, some components of the tool storage 1B and the machine tool 100B (for example, the housing) are omitted.

The following description of the second embodiment will mainly focus on those respects in which this embodiment is different from the first embodiment. Also in the following description of the second embodiment, those respects that have already been described in the first embodiment will not be repeated. Thus, it will be readily appreciated that those respects that are not explicitly described in the second embodiment but are described in the first embodiment apply in the second embodiment.

In the example illustrated in FIG. 5, the tool storage 1B includes the tool receiver 10, the tool magazine 20, and the tool carriage 50. The tool storage 1B may include the tool exchanger 60, the controller 90, and/or the housing 80. In the example illustrated in FIG. 5, the machine tool 100B includes the machining apparatus 30 and the workpiece holder 40, in addition to the tool storage 1B.

The tool receiver 10, the tool magazine 20, the machining apparatus 30, the workpiece holder 40, the tool carriage 50, the tool exchanger 60, the controller 90, and the housing 80 are as outlined in the first embodiment. Redundant description of these elements will not be provided here.

In the example illustrated in FIG. 5, the tool receiver 10 is provided at a position further in the first direction DR1 than the workpiece holder 40, and the tool magazine 20 is provided at a position further in the second direction DR2 than the workpiece holder 40. Alternatively or additionally, the tool receiver 10 may be provided in the first region AR1, and the tool magazine 20 may be provided in the second region AR2, which is a region that is further away from the access opening AS than the first region AR1 is away from the access opening AS.

In the example illustrated in FIG. 5, the tool storage 1B (or the machine tool 100B) includes the tool carriage 50, which is capable of carrying the tool C between the tool receiver 10 and the tool magazine 20. With this configuration, the tool storage 1B (or the machine tool 100B) according to the second embodiment provides advantageous effects similar to the advantageous effects provided by the tool storage 1A (or the machine tool 100A) according to the first embodiment.

### Tool Receiver 10

In the example illustrated in FIG. 6, the tool receiver 10 includes: the tool support member 11, which supports the tool C; and the driver 12, which moves the tool support member 11. The tool receiver 10 may include the guide member 13, which guides the movement of the tool support member 11.

The tool support member 11 includes grippers 110, which are capable of gripping a first portion Cb (see FIG. 11) of the tool C. The grippers 110 include a first gripper 110a and a second gripper 110b. The second gripper 110b is preferably biased toward the first gripper 110a. In this case, by pressing the first portion Cb of the tool C into the region between the first gripper 110a and the second gripper 110b, the tool C is automatically gripped by the grippers 110.

The driver 12 moves the tool support member 11 between the first position P1 and the second position P2. The first position P1 is a position at which the tool C is receivable by the tool support member 11 from outside the machine tool 100A. The second position P2 is a position at which the tool C is transferable from the tool support member 11 to the tool carriage 50. In the example illustrated in FIG. 6, the second position P2 is above the first position P1. The second position P2 may be a position perpendicularly above the first position P1.

As illustrated in FIG. 5, the tool support member 11 provided at the first position P1 is preferably visually recognizable through the access opening AS, which is provided on the housing 80 (the access opening AS is an opening allowing access to the inside of the machine tool 100B). For example, the access opening AS is provided on the front surface 101a of the machine tool 100A.

### Tool Carriage 50

As illustrated in FIG. 7, the tool carriage 50 is capable of receiving the tool C from the tool receiver 10. Also, the tool carriage 50 is capable of carrying the tool C between the tool receiver 10 and the tool magazine 20. When the tool storage 1B (or the machine tool 100B) includes the tool exchanger 60, the tool carriage 50 is preferably capable of carrying the tool C between the tool receiver 10 and the tool exchanger 60. Also, the tool carriage 50 is preferably capable of carrying the tool C between the tool magazine 20 and the tool exchanger 60.

The tool carriage 50 includes: the carrier 52, which is movable along the trajectory OB; a guide member 54, which defines the trajectory OB; and a carrier driver 56, which moves the carrier 52 along the guide member 54. In the example illustrated in FIG. 7, the guide member 54 extends along a horizontal direction, for example. The guide member 54 preferably extends in a direction from a first surface of the machine tool 100B toward a second surface of the machine tool 100B. The first surface of the machine tool 100B is the surface on which the access opening AS is provided (for example, the front surface of the machine tool 100B), and the second surface of the machine tool 100B is the surface facing the first surface of the machine tool 100B (for example, the back surface of the machine tool 100B).

The carrier 52 is movable between the third position P3 and the fourth position P4. The third position P3 is a position at which the tool C is receivable by the carrier 52 from the tool receiver 10. Also, the third position P3 is located near the second position P2. The fourth position P4 is a position at which the tool C is transferable from the carrier 52 to the tool magazine 20. The fourth position P4 is located near the tool magazine 20. Also, the fourth position P4 is further in the second direction DR2 than the third position P3.

In the example illustrated in FIG. 8, the carrier 52 is preferably movable between the third position P3 (or the fourth position P4) and a fifth position P5. The fifth position P5 is a position corresponding to the tool exchange position Pe. In other words, by moving the carrier 52 to the fifth position P5, the tool C held by the carrier 52 can be moved to the tool exchange position Pe. The fifth position P5 is located between the third position P3 and the fourth position P4. The third position P3, the fourth position P4, and the fifth position P5 are preferably provided on a line.

In the example illustrated in FIG. 9, the carrier 52 includes a carrier body 520 and the holder 521, which is capable of holding the tool C. The holder 521 is movable relative to the carrier body 520.

In the example illustrated in FIG. 9, the carrier 52 includes: the arm 523, which supports the holder 521; and the first driver 525, which rotates the arm 523 about a pivot axis AX2. The extending direction of the pivot axis AX2 is, for example, a direction perpendicular to the extending direction of the trajectory OB of the carrier 52 (in other words, the guide member 54).

A first end portion of the arm 523 is connected to the carrier body 520, and a second end portion of the arm 523 is connected to the holder 521. By rotating the arm 523 about the pivot axis AX2, the first driver 525 moves the arm 523 (more specifically, the holder 521) between the first proceeding position T1 (see the broken lines illustrated in FIG. 9) and the first withdrawal position T2 (see the solid lines illustrated in FIG. 9). An example of the first proceeding position T1 is a position at which the angle defined between the longitudinal direction of the arm 523 and the trajectory OB of the carrier 52 is relatively large. An example of the first withdrawal position T2 is a position at which the angle defined between the longitudinal direction of the arm 523 and the trajectory OB of the carrier 52 is relatively small. The first withdrawal position T2 may be a position at which the longitudinal direction of the arm 523 and the trajectory OB of the carrier 52 are parallel to each other.

When the carrier 52 moves to the fifth position P5 and the arm 523 moves from the first withdrawal position T2 to the first proceeding position T1, the tool C held by the carrier 52 is moved to the tool exchange position Pe (see FIG. 8).

When the carrier 52 moves to the fourth position P4 and the arm 523 moves from the first withdrawal position T2 to the first proceeding position T1, the tool C held by the carrier 52 is transferred to the tool holder 21 of the tool magazine 20 (see the broken lines illustrated in FIG. 12).

In the example illustrated in FIG. 10, the carrier 52 includes a second driver 528, which moves the holder 521 between a second proceeding position T3 (see the broken lines illustrated in FIG. 10) and a second withdrawal position T4 (see the solid lines illustrated in FIG. 10). By moving the holder 521 from the second withdrawal position T4 to the second proceeding position T3, the second driver 528 causes the holder 521 to hold the tool C. Also, by moving the holder 521 from the second proceeding position T3 to the second withdrawal position T4, the second driver 528 causes the holder 521 to release the tool C. The direction from the second withdrawal position T4 toward the second proceeding position T3 is, for example, a direction perpendicular to the extending direction of the trajectory OB of the carrier (in other words, the guide member 54). Also, the direction from the second withdrawal position T4 toward the second proceeding position T3 is, for example, a direction parallel to the pivot axis AX2.

### Tool C

In the example illustrated in FIG. 11, the tool C has: a tool body Ca; the first portion Cb, which is externally holdable by the tool support member 11 of the tool receiver 10 or the tool holder 21 of the tool magazine 20; and a second portion Cd, which is holdable by the holder 521 of the carrier 52.

The first portion Cb has a ring-shaped groove Cb1. When the tool support member 11 (or the tool holder 21) and the ring-shaped groove Cb1 are engaged with each other, the tool C is held by the tool support member 11 (or the tool holder 21) such that the tool C is unmovable in a direction along the longitudinal axis, AX3, of the tool C.

The second portion Cd has a base end portion Cd1, which is holdable by the holder 521. The base end portion Cd1 has a tapered surface having an outer diameter that diminishes toward a base end surface Ce of the tool C.

In the example illustrated in FIG. 11, the tool C has: the first portion Cb, which is grippable by the tool receiver 10 (or the tool magazine 20); and the second portion Cd, which is holdable by the carrier 52. This ensures that the tool C can be smoothly transferred between the tool receiver 10 (or the tool magazine 20), which is capable of gripping the first portion Cb, and the carrier 52, which is capable of holding the second portion Cd, which is different from the first portion Cb.

### Tool Magazine 20

The tool magazine 20 is capable of storing therein a plurality of tools C. In the example illustrated in FIG. 13, the tool magazine 20 includes a plurality of tool holders 21, the endless chain 23, and a driver 24, which drives the endless chain 23. In the example illustrated in FIG. 13, the driver 24 drives the endless chain 23 via a sprocket 25. With this configuration, the plurality of tool holders 21, which are mounted on the endless chain 23, make a circulation motion.

Each tool holder 21 includes a gripper 210, which is capable of gripping the first portion Cb of the tool C (more specifically, the ring-shaped groove Cb1). The gripper 210 is biased by a biasing member, and the tool holder 21 holds the tool C using the biasing force of the biasing member.

### Tool Exchanger 60

In the example illustrated in FIG. 5, the tool exchanger 60 includes: an exchanger body 61; a support member 68, which supports the exchanger body 61 linearly movably; and a linear motion driver 69, which moves the exchanger body 61 relative to the support member 68. The linear motion driver 69 moves the exchanger body 61 in a direction along a fourth direction DR4. The fourth direction DR4 is, for example, a direction perpendicular to the vertical direction. Also, the fourth direction DR4 is, for example, a direction perpendicular to the extending direction of the trajectory OB of the carrier (in other words, the guide member 54).

In the example illustrated in FIG. 5, the tool exchanger 60 includes the linear motion driver 69, which moves the exchanger body 61 linearly in the direction along the fourth direction DR4. In this case, even if the position of the tool carriage 50 in the direction along the fourth direction DR4 is different from the position of the machining apparatus 30 in the direction along the fourth direction DR4, the tool C (the first tool C1) held by the tool carriage 50 and the tool C (the second tool C2) held by the machining apparatus 30 can be exchanged with each other.

In the example illustrated in FIG. 13, the tool exchanger 60 (more specifically, the exchanger body 61) includes: a first aim 63a, which includes a first gripper 62a; a second arm 63b, which includes a second gripper 62b; and a swing motion driver 64, which causes the first arm 63a and the second arm 63b to swing about a first axis AX1. The extending direction of the first axis AX1 is a direction parallel to the fourth direction DR4.

In the example illustrated in FIG. 13, the tool exchanger 60 includes the swing motion driver 64, which causes the first arm 63a and the second arm 63b to swing. In this case, by causing the first arm 63a and the second arm 63b to swing, the first gripper 62a or the second gripper 62b is moved to the tool exchange position Pe. Also, by causing the first arm 63a and the second arm 63b to swing after moving the exchanger body 61 in the fourth direction DR4, the first gripper 62a or the second gripper 62b is moved to a second tool exchange position Pf. The second tool exchange position Pf is a position at which the tool C is transferable from the tool exchanger 60 to the machining apparatus 30.

In the example illustrated in FIG. 13, the first arm 63a and the second arm 63b are arranged in a V shape. In this case, when the first tool C1 held by the tool carriage 50 and the second tool C2 held by the machining apparatus 30 are exchanged with each other, the swing motion displacement of each of the first arm 63a and the second arm 63b is minimized. By minimizing the swing motion displacement of each of the first arm 63a and the second arm 63b, the time spent in exchanging the first tool C1 and the second tool C2 with each other is shortened.

The first arm 63a and the second arm 63b may be made up of a single integrated component. Alternatively, the first aim 63a and the second arm 63b may be an assembly of a plurality of components.

Each of the first gripper 62a and the second gripper 62b is capable of gripping the first portion Cb of the tool C (more specifically, the ring-shaped groove Cb1 (see FIG. 11)). Each of the first gripper 62a and the second gripper 62b preferably includes a lock member 620, which prevents unexpected removal of the tool C. The lock member 620 is movable between a lock position and a lock release position. The movement of the lock member 620 is implemented by, for example, a driver such as an air actuator.

In the example illustrated in FIG. 13, the tool receiving opening of the first gripper 62a and the tool receiving opening of the second gripper 62b are open in the same direction as seen in the swing direction of the first arm 63a and the second arm 63b. In this case, by rotating the first arm 63a about the first axis AX1 in a first rotation direction, the first gripper 62a is able to receive the tool C provided at the tool exchange position Pe or the second tool exchange position Pf. Also, by rotating the second arm 63b about the first axis AX1 in the first rotation direction, the second gripper 62b is able to receive the tool C provided at the tool exchange position Pe or the second tool exchange position Pf. Alternatively, the tool receiving opening of the first gripper 62a and the tool receiving opening of the second gripper 62b may be open in opposite directions as seen in the swing direction of the first arm 63a and the second arm 63b. In this case, the rotation direction of the first aim 63a at the time when the first gripper 62a receives the tool C is a direction opposite to the rotation direction of the second arm 63b at the time when the second gripper 62b receives the tool C.

In the example illustrated in FIG. 14, when the first arm 63a or the second arm 63b makes an imaginary 360-degree rotation about the first axis AX1, an imaginary circle HC is drawn. A different member (“a first member”) (for example, a support member 68, which supports the exchanger body 61) different from a member (“a second member”) that rotates about the first axis AX1 together with the first arm 63a is provided at a position where the different member interferes with the imaginary circle HC. Thus, a different member different from the first arm 63a and a member (for example, the second arm 63b) that rotates about the first axis AX1 integrally with the first arm 63a is purposefully provided at a position where the different member interferes with the imaginary circle HC. This configuration makes the tool exchanger 60 or the machine tool 100B compact in size.

It will be assumed that the angle defined between the first arm 63a and the second arm 63b is 180 degrees. In this case, if the first arm 63a and the second arm 63b rotate by 180 degrees, the region covered by the first arm 63a and the region covered by the second arm 63b form a circle. It will be assumed that the angle defined between the first arm 63a and the second arm 63b is less than 180 degrees (in other words, a case where the first arm 63a and the second arm 63b are arranged in a V shape). In this case, if the first arm 63a and the second arm 63b rotate by 180 degrees, a complete circle is not formed by the region covered by the first arm 63a and the region covered by the second arm 63b. Therefore, the configuration in which the first arm 63a and the second arm 63b are arranged in a V shape provides a greater degree of freedom on the design that a different member different from the member that rotates about the first axis AX1 is provided at a position where the different member interferes with the imaginary circle HC, as compared with the case where the angle defined between the first arm 63a and the second arm 63b is 180 degrees.

From the viewpoint of shortening the time spent in exchanging the first tool C1 and the second tool C2 with each other; or from the viewpoint of realizing the configuration in which a different member different from the member that rotates about the first axis AX1 is provided at a position where the different member interferes with the imaginary circle HC, the angle defined between the first arm 63a and the second arm 63b is preferably less than 180 degrees, less than 120 degrees, or less than 90 degrees.

In the example illustrated in FIG. 13, the tool carriage 50 is capable of transferring the tool C to each of the tool receiver 10, the tool magazine 20, and the tool exchanger 60. Also, the tool carriage 50 is capable of receiving the tool from each of the tool receiver 10, the tool magazine 20, and the tool exchanger 60. The configuration in which the tool carriage 50 is capable of transferring the tool C to each of at least three apparatuses and/or devices (the tool receiver 10, the tool magazine 20, and the tool exchanger 60) increases the degree of freedom in the operation of the machine tool 100B while eliminating or minimizing an increase in the number of tool carriages. For example, in the example illustrated in FIG. 13, the tool carriage 50 is capable of (1) carrying the tool C from the tool receiver 10 to the tool magazine 20, (2) carrying the tool C from the tool receiver 10 to the tool exchanger 60, (3) carrying the tool C from the tool magazine 20 to the tool receiver 10, (4) carrying the tool C from the tool magazine 20 to the tool exchanger 60, (5) carrying the tool from the tool exchanger 60 to the tool receiver 10, and (6) carrying the tool C from the tool exchanger 60 to the tool magazine 20.

Also in the example illustrated in FIG. 13, each of the tool receiver 10, the tool magazine 20, and the tool exchanger 60 is capable of gripping the first portion Cb of the tool C (more specifically, the ring-shaped groove Cb1 of the tool C). Also, the tool carriage 50 (more specifically, the carrier 52) is capable of holding the second portion Cd of the tool C, which is different from the first portion Cb (more specifically, the tapered base end portion Cd1 of the tool C). With this configuration in the example illustrated in FIG. 13, the tool C can be smoothly transferred between the tool carriage 50 and each of the tool receiver 10, the tool magazine 20, and the tool exchanger 60.

### Machining Apparatus 30

In the example illustrated in FIG. 5, the machining apparatus 30 is supported by a base 85 movably relative to the base 85. The machining apparatus 30 includes a tool holding member 32 (for example, a tool headstock), which holds the tool. The tool holding member 32 is preferably movable in a direction parallel to the first axis AX1 (in other words, in a direction parallel to the fourth direction DR4). In this case, the tool holding member 32 (and the tool C held by the tool holding member 32) is movable closer to the tool exchanger 60. Also, the tool holding member 32 is preferably movable in a direction parallel to the first direction DR1, and is preferably movable in the vertical direction.

Also, the tool holding member 32 is preferably rotatable about to an axis AX4, which is perpendicular to the first axis AX1 (more specifically, an axis parallel to the first direction DR1). In this case, by rotating the tool holding member 32 about the axis AX4, the center axis of the tool C held by the tool holding member 32 and the first axis AX1 of the tool exchanger 60 can be made parallel to each other.

### Workpiece Holder 40

In the example illustrated in FIG. 5, the workpiece holder 40 includes: a chuck 42 (for example, workpiece spindle), which holds a workpiece; and a support member 44 (for example, workpiece headstock), which supports the chuck 42 rotatably about the rotation axis AX. An example of the rotation axis AX is an axis perpendicular to the first direction DR1. A more specific example is an axis parallel to the first axis AX1 of the tool exchanger 60.

### Controller 90

In the example illustrated in FIG. 5, the tool storage 1B (or the machine tool 100B) includes the tool magazine 20 and the controller 90, which controls the tool carriage 50. The controller 90 is preferably capable of controlling the tool receiver 10 and/or the machining apparatus 30. Also, the controller 90 is preferably capable of controlling the tool exchanger 60.

### First Control Mode

The controller 90 is capable of executing the first control mode by controlling the tool carriage 50 to carry the tool C from the tool receiver 10 to the tool magazine 20. The first control mode is a control mode for storing the tool C at the tool receiver 10 in the tool magazine 20.

The first control mode may include moving the tool support member 11, which is supporting the tool C, from the first position P1 to the second position P2 (see FIG. 7). This operation is executed by the controller 90 controlling the driver 12 of the tool receiver 10.

The first control mode may include moving, from the third position P3 to the fourth position P4, the carrier 52 that has received the tool C from the tool support member 11 (see FIG. 7). This operation is executed by the controller 90 controlling the carrier driver 56 of the tool carriage 50.

The first control mode may include moving the holder 521 of the carrier 52 from the first withdrawal position T2 to the first proceeding position T1 (see FIG. 12). This operation is executed by the controller 90 controlling the first driver 525 of the tool carriage 50. By moving the holder 521 to the first proceeding position T1, the tool magazine 20 (more specifically, the tool holder 21) is able to receive the tool C from the holder 521.

The first control mode may include moving the holder 521 of the carrier 52 from the second proceeding position T3 to the second withdrawal position T4. This operation is executed by the controller 90 controlling the second driver 528 of the tool carriage 50 (see FIG. 10). By moving the holder 521 to the second withdrawal position T4, the holder 521 is able to release the tool C. Thus, the tool C is transferred from the holder 521 of the carrier 52 to the tool holder 21 of the tool magazine 20.

### Second Control Mode

The controller 90 is capable of executing the second control mode by: controlling the tool carriage 50 to carry the tool C (the first tool C1) from the tool receiver 10 to the tool exchange position Pe; and controlling the tool exchanger 60 to attach, to the machining apparatus 30, the tool C (the first tool C1) provided at the tool exchange position Pe. The second control mode is a control mode for attaching, to the machining apparatus 30, the tool C (the first tool C1) provided at the tool receiver 10.

The second control mode may include moving the tool support member 11, which is supporting the tool C (the first tool C1), from the first position P1 to the second position P2 (see FIG. 7). This operation is executed by the controller 90 controlling the driver 12 of the tool receiver 10.

The second control mode may include moving, from the third position P3 to the fifth position P5, the carrier 52 that has received the tool C (the first tool C1) from the tool support member 11. This operation is executed by the controller 90 controlling the carrier driver 56 of the tool carriage 50 (see FIG. 8).

The second control mode may include moving the holder 521 of the carrier 52 (the carrier 52 provided at the fifth position P5) from the first withdrawal position T2 to the first proceeding position T1 (see FIG. 8). This operation is executed by the controller 90 controlling the first driver 525 of the tool carriage 50. By moving the holder 521 to the first proceeding position T1, the tool C (the first tool C1) held by the holder 521 is moved to the tool exchange position Pe.

The second control mode may include moving the first gripper 62a or the second gripper 62b of the tool exchanger 60 to the tool exchange position Pe (see FIG. 13). This operation is executed by the controller 90 controlling the swing motion driver 64 of the tool exchanger 60. By moving the first gripper 62a or the second gripper 62b to the tool exchange position Pe, the first gripper 62a or the second gripper 62b is able to receive the tool C (the first tool C1) from the holder 521.

The second control mode may include moving the holder 521 of the carrier 52 from the second proceeding position T3 to the second withdrawal position T4 (see FIG. 10). This operation is executed by the controller 90 controlling the second driver 528 of the tool carriage 50. By moving the holder 521 to the second withdrawal position T4, the holder 521 is able to release the tool C (the first tool C1). Thus, the tool C (the first tool C1) is transferred from the holder 521 of the carrier 52 to the tool exchanger 60.

The second control mode may include causing the first gripper 62a or the second gripper 62b that has received the tool C (the first tool C1) to make a swing motion from the angle position corresponding to the tool exchange position Pe to another angle position (compare FIG. 13 and FIG. 15 with each other). This operation is executed by the controller 90 controlling the swing motion driver 64 of the tool exchanger 60. Also, the second control mode may include moving the exchanger body 61 of the tool exchanger 60 in a direction approaching the machining apparatus 30 (more specifically, in the fourth direction DR4) (see FIG. 15). This operation is executed by the controller 90 controlling the linear motion driver 69 of the tool exchanger 60.

In the examples illustrated in FIGS. 13 and 15, the first gripper 62a or the second gripper 62b makes a swing motion over a small swing distance from the angle position corresponding to the tool exchange position Pe to another angle position. In the example illustrated in FIG. 15, when the exchanger body 61 moves in the fourth direction DR4, the first arm 63a passes through the space on the left side of the holder 521, and the second arm 63b passes through the space on the right side of the holder 521.

The second control mode may include moving the first gripper 62a or the second gripper 62b of the tool exchanger 60 to the second tool exchange position Pf. This operation is executed by the controller 90 controlling the swing motion driver 64 of the tool exchanger 60. Thus, the tool C (the first tool C1) gripped by the first gripper 62a or the second gripper 62b is attached to the machining apparatus 30. It is to be noted that in the example illustrated in FIG. 15, the tool (the second tool C2) is attached to the machining apparatus 30. In this case, the second tool C2 held by the machining apparatus 30 is retrieved by the second gripper 62b before the first tool C1 gripped by the first gripper 62a is attached to the machining apparatus 30.

### Third Control Mode

The controller 90 is capable of executing a third control mode by: controlling the tool carriage 50 to carry the tool C (the first tool C1) from the tool magazine 20 to the tool exchange position Pe; and controlling the tool exchanger 60 to attach, to the machining apparatus 30, the tool C (the first tool C1) provided at the tool exchange position Pe. The third control mode is a control mode for attaching, to the machining apparatus 30, the tool C (the first tool C1) stored in the tool magazine 20.

The third control mode may include moving the holder 521 of the carrier 52 from the first withdrawal position T2 to the first proceeding position T1. This operation is executed by the controller 90 controlling the first driver 525 of the tool carriage 50. By moving the holder 521 to the first proceeding position T1, the holder 521 is able to receive the tool C (the first tool C1) held by the tool magazine 20 (more specifically, the tool holder 21). Also, the third control mode may include moving the holder 521 of the carrier 52 from the first proceeding position T1 to the first withdrawal position T2. This operation is executed by the controller 90 controlling the first driver 525 of the tool carriage 50. By moving the holder 521 to the first withdrawal position T2, the tool C (the first tool C1) held by the holder 521 is lifted up to the withdrawal position.

The third control mode may include moving, from the fourth position P4 to the fifth position P5, the carrier 52 that has received the tool C (the first tool C1) from the tool magazine 20 (see FIG. 8). This operation is executed by the controller 90 controlling the carrier driver 56 of the tool carriage 50.

The third control mode may include moving the holder 521 of the carrier 52 (the carrier 52 provided at the fifth position P5) from the first withdrawal position T2 to the first proceeding position T1 (see FIG. 8). This operation is executed by the controller 90 controlling the first driver 525 of the tool carriage 50. By moving the holder 521 to the first proceeding position T1, the tool C (the first tool C1) held by the holder 521 is moved to the tool exchange position Pe. There is no difference between the third control mode and the second control mode in the operations made after the holder 521 has moved to the tool exchange position Pe. In light of this fact, redundant description of the operations made after the holder 521 has moved to the tool exchange position Pe will be omitted.

In the second embodiment, the controller 90 is preferably capable of selectively executing a plurality of control modes, namely, the first control mode, the second control mode, and the third control mode. A control mode may be selected using an input device 94, such as a touch panel (see FIG. 5). In other words, the machine tool 100B may include the input device 94, through which to specify the control mode to execute, from among the plurality of control modes, namely, the first control mode, the second control mode, and the third control mode.

### Third Embodiment

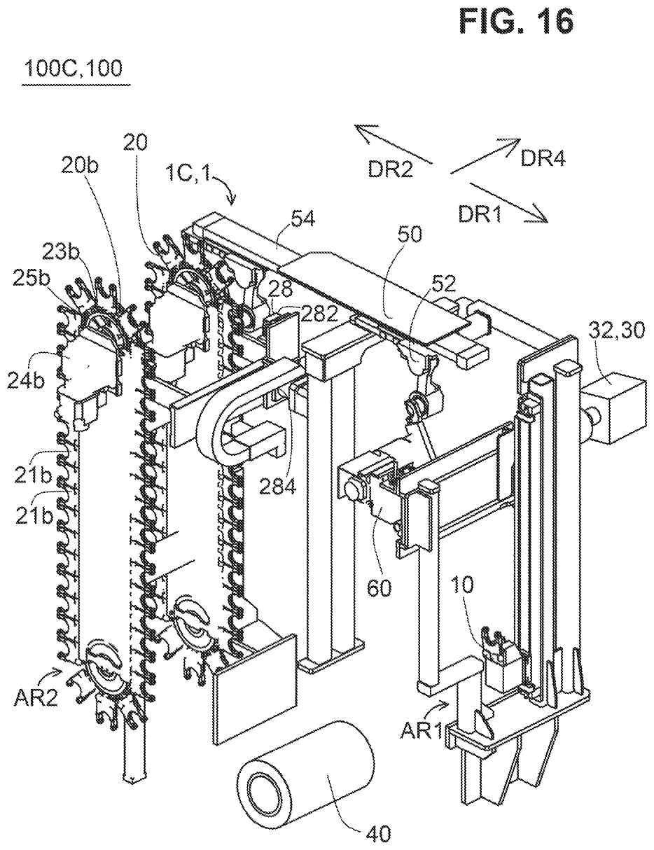

By referring to FIG. 16, a tool storage 1C and a machine tool 100C according to the third embodiment will be described. FIG. 16 is a schematic perspective view of the machine tool 100C according to the third embodiment. It is to be noted that in FIG. 16, some components of the machine tool 100C (for example, the housing) are omitted.

The tool storage 1C (or the machine tool 100C) according to the third embodiment is different from the tool storage 1A (or the machine tool 100A) according to the first embodiment and from the tool storage 1B (or the machine tool 100B) according to the second embodiment in that the tool storage 1C (or the machine tool 100C) includes a second tool magazine 20b and a second tool carriage 28. In other respects, the tool storage 1C (or the machine tool 100C) according to the third embodiment is similar to the tool storage 1A (or the machine tool 100A) according to the first embodiment or to the tool storage 1B (or the machine tool 100B) according to the second embodiment.

The following description of the third embodiment will mainly focus on the second tool magazine 20b and the second tool carriage 28, and will omit those respects that have already been described in the first embodiment or the second embodiment. Thus, it will be readily appreciated that those respects that are not explicitly described in the third embodiment but are described in the first embodiment or the second embodiment apply in the third embodiment.

In the example illustrated in FIG. 16, the tool storage 1C (or the machine tool 100C) includes a second tool magazine 20b, in addition to the tool magazine 20. The tool storage 1C (or the machine tool 100C) may include a third tool magazine.

In the example illustrated in FIG. 16, the second tool magazine 20b is provided at a position further in the second direction DR2 than the workpiece holder 40. Alternatively or additionally, the second tool magazine 20b may be provided in the second region AR2 in the housing. The second tool magazine 20b is an apparatus capable of storing a plurality of tools C. In the example illustrated in FIG. 16, the second tool magazine 20b includes a plurality of tool holders 21b, an endless chain 23b, and a driver 24b, which drives the endless chain 23b. In the example illustrated in FIG. 16, the driver 24b drives the endless chain 23b via a sprocket 25b. With this configuration, the plurality of tool holders 21b, which are mounted on the endless chain 23b, make a circulation motion.

In the example illustrated in FIG. 16, the tool magazine 20 and the second tool magazine 20b are provided along a direction perpendicular to the carrying passage (in other words, the guide member 54) defined by the tool carriage 50. More specifically, the tool magazine 20 and the second tool magazine 20b are provided along the back surface of the machine tool 100C. The distance between the second tool magazine 20b and the tool carriage 50 is larger than the distance between the tool magazine 20 and the tool carriage 50. In this case, it is difficult for the carrier 52 of the tool carriage 50 to transfer the tool C directly to the second tool magazine 20b.

Under the circumstances, in the example illustrated in FIG. 16, the tool storage 1C (or the machine tool 100C) includes the second tool carriage 28, which is capable of carrying the tool C between the tool magazine 20 and the second tool magazine 20b.

The second tool carriage 28 includes: a second carrier 282, which is capable of holding the tool C (more specifically, a second portion Cd of the tool C or the tapered base end portion Cd1 of the tool C); and a second carrier driver 284, which moves the second carrier 282.

The second carrier 282 is preferably movable in a direction parallel to a direction from the tool magazine 20 toward the second tool magazine 20b (for example, movable in a direction parallel to the fourth direction DR4). In other words, the second carrier driver 284 is preferably capable of moving the second carrier 282 in a direction parallel to the direction from the tool magazine 20 toward the second tool magazine 20b (for example, moving the second carrier 282 in the direction parallel to the fourth direction DR4).

Also, the second carrier 282 is preferably movable in a direction parallel to the carrying passage defined by the tool carriage 50 (for example, movable in a direction parallel to the first direction DR1). In other words, the second carrier driver 284 is preferably capable of moving the second carrier 282 in the direction parallel to the carrying passage defined by the tool carriage 50 (for example, moving the second carrier 282 in the direction parallel to the first direction DR1).

The tool storage 1C (or the machine tool 100C) according to the third embodiment provides advantageous effects similar to the advantageous effects provided by the tool storage 1A (or the machine tool 100A) according to the first embodiment and/or the tool storage 1B (or the machine tool 100B) according to the second embodiment. Additionally, the tool storage 1C (or the machine tool 100C) according to the third embodiment includes a plurality of tools magazines (20 and 20b). This increases the capacity of the tool storage 1C (or the machine tool 100C) for storing tools C. Further, the front surface-side shapes of, for example, the machine tool 100A according to the first embodiment, the machine tool 100B according to the second embodiment, and the machine tool 100C according to the third embodiment can be made the same, flat shapes. This ensures that automation units (such as a robot, an automatic carrier, and an auto parts catcher) can be arranged with a higher degree of freedom on a machining line on which machines having different tool capacities are arranged.

Also, the tool storage 1C (or the machine tool 100C) according to the third embodiment includes the second tool carriage 28, which is capable of carrying the tool C between the tool magazine 20 and the second tool magazine 20b. In this case, the tool C can be smoothly transferred between a plurality of tools magazines.

In the example illustrated in FIG. 16, the tool magazine 20 and the second tool magazine 20b are provided along a direction perpendicular to the carrying passage defined by the tool carriage 50. Alternatively, the tool magazine 20 and the second tool magazine 20b may be provided along a direction parallel to the carrying passage defined by the tool carriage 50. In this case, the tool C may be transferred between the tool magazine 20 and the second tool magazine 20b by the tool carriage 50. In other words, the second tool carriage 28 may be omitted.

The present invention will not be limited to the above-described embodiments; it will be appreciated that the embodiments may be modified or changed in any manner deemed convenient within the technical spirit and scope of the present invention. It will also be appreciated that the various kinds of technology and/or technique used in one embodiment are applicable to the other embodiments unless a technical contradiction occurs. Further, it will be appreciated that the optional configurations in each embodiment may be omitted if deemed necessary.

For example, in the above-described embodiments, the tool magazine 20 is described as being a tool magazine capable of making a circulation motion of the tools C along a vertical surface. Alternatively, the tool magazine 20 may be a tool magazine capable of making a circulation motion of the tools C along a horizontal surface, or even may be a tool magazine having any other form.

In the above-described embodiments, it may be a robot, instead of a worker, that provides the tool C to the tool receiver 10. In other words, the tool receiver 10 may be used as an intermediate point of tool transportation on an automated line.

In the above-described embodiments, the tool support member 11 of the tool receiver 10 is described as being movable. Alternatively, the tool support member 11 of the tool receiver 10 may be unmovable. In this case, the tool carriage 50 is preferably capable of moving upward and downward the tool received from the tool receiver 10. For example, the tool carriage 50 may be capable of moving the carrier 52 between the third position P3 and the fourth position P4, and capable of moving the carrier 52 between the first position P1 and the second position P2.

As used herein, the term “comprise” and its variations are intended to mean open-ended terms, not excluding any other elements and/or components that are not recited herein. The same applies to the terms “include”, “have”, and their variations.

As used herein, a component suffixed with a tem' such as “member”, “portion”, “part”, “element”, “body”, and “structure” is intended to mean that there is a single such component or a plurality of such components.

As used herein, ordinal terms such as “first” and “second” are merely used for distinguishing purposes and there is no other intention (such as to connote a particular order) in using ordinal terms. For example, the mere use of “first element” does not connote the existence of “second element”; otherwise, the mere use of “second element” does not connote the existence of “first element”.

As used herein, approximating language such as “approximately”, “about”, and “substantially” may be applied to modify any quantitative representation that could permissibly vary without a significant change in the final result obtained. All of the quantitative representations recited in the present application shall be construed to be modified by approximating language such as “approximately”, “about”, and “substantially”.

As used herein, the phrase “at least one of A and B” is intended to be interpreted as “only A”, “only B”, or “both A and B”.

Obviously, numerous modifications and variations of the present disclosure are possible in light of the above teachings. It is therefore to be understood that within the scope of the appended claims, the present disclosure may be practiced otherwise than as specifically described herein.

What is claimed is:

1. A tool storage comprising:
a tool receiver provided on a one side of a machine tool with respect to a workpiece holder of the machine tool along a machine tool direction and configured to receive a tool from an outside of the machine tool;
a tool magazine provided on another side opposite to the one side with respect to the workpiece holder along the machine tool direction; and
a tool carriage configured to carry the tool between the tool receiver and the tool magazine.

2. The tool storage according to claim 1, wherein the machine tool direction extends along a line connecting a back surface of the machine tool and a front surface of the machine tool.

3. The tool storage according to claim 1, further comprising:
a tool exchanger configured to exchange a first tool and a second tool, the first tool being carried to a tool exchange position by the tool carriage, the second tool being attached to a machining apparatus of the machine tool.

4. The tool storage according to claim 3,
wherein the tool exchanger comprises
a first arm comprising a first gripper,
a second arm comprising a second gripper,
a swing motion driver configured to swing the first arm and the second arm about a first axis, and
a linear motion driver configured to move the first arm and the second arm linearly in a direction along the first axis, and
wherein the first arm and the second arm are arranged in a V shape.

5. The tool storage according to claim 4, wherein a first member different from a second member that rotates about the first axis together with the first arm is provided at a position where the first member interferes with an imaginary circle drawn by the first arm when the first arm makes an imaginary 360-degree rotation about the first axis.

6. The tool storage according to claim 3, further comprising:
a controller configured to control the tool carriage and the tool exchanger, the controller being configured to selectively execute
a first control mode in which the controller is configured to control the tool carriage to carry the tool from the tool receiver to the tool magazine, and
a second control mode in which the controller is configured to the tool carriage to carry the tool from the tool receiver to the tool exchange position, and configured to control the tool exchanger to attach, to the machining apparatus, the tool provided at the tool exchange position.

7. The tool storage according to claim 3,
wherein the tool carriage is configured to transfer the tool to each of the tool receiver, the tool magazine, and the tool exchanger,
wherein the tool carriage is configured to receive the tool from each of the tool receiver, the tool magazine, and the tool exchanger,
wherein each of the tool receiver, the tool magazine, and the tool exchanger is configured to grip a first portion of the tool, and
wherein the tool carriage is configured to hold a second portion of the tool different from the first portion of the tool.

8. The tool storage according to claim 1, wherein the tool receiver comprises
a tool support member configured to support the tool, and
a driver configured to move the tool support member between a first position and a second position.

9. The tool storage according to claim 1, wherein a carrying passage along which the tool carriage is configured to carry the tool is provided above, in a height direction of the machine tool, a first position at which the tool receiver is configured to receive the tool from the outside of the machine tool.

10. The tool storage according to claim 1, further comprising:
a second tool magazine provided on the another side; and
a second tool carriage configured to carry the tool between the tool magazine and the second tool magazine.

11. The tool storage according to claim 1, further comprising:
a housing having an access opening, the tool receiver being provided to be accessible via the access opening.

12. The tool storage according to claim 11, wherein the housing has a second access opening through which the tool magazine is accessible.

13. The tool storage according to claim 1, further comprising:
an auxiliary magazine configured to store the tool; and
a tool transferor configured to transfer the tool between the tool receiver and the auxiliary magazine.

14. A machine tool comprising:
a workpiece holder configured to hold a workpiece;
a machining apparatus to which a tool is attachable;
a tool receiver provided between the workpiece holder and a front of the machine tool, and configured to receive a tool from an outside of the machine tool;
a tool magazine provided between the workpiece holder and a back of the machine tool; and
a tool carriage configured to carry the tool between the tool receiver and the tool magazine.

15. A tool storage comprising:
a housing having a front and a back, the front having an access opening;
a tool receiver provided in the housing and configured to receive a tool from an outside of the machine tool via the access opening;
a tool magazine provided in the housing between the tool receiver and the back of the housing; and
a tool carriage configured to carry the tool between the tool receiver and the tool magazine.

16. The tool storage according to claim 2, further comprising:
a tool exchanger configured to exchange a first tool and a second tool, the first tool being carried to a tool exchange position by the tool carriage, the second tool being attached to a machining apparatus of the machine tool.

17. The tool storage according to claim 2, further comprising:
a housing having an access opening, the tool receiver being provided to be accessible via the access opening.

18. The tool storage according to claim 13, wherein the auxiliary magazine is configured to store a plurality of tools.
